(19) United States
(12) Patent Application Publication
(10) Pub. No.: US 2020/0258379 A1
(43) Pub. Date: Aug. 13, 2020

(54) DETERMINATION OF MOVEMENT INFORMATION WITH SURROUNDINGS SENSORS

(71) Applicant: Valeo Schalter und Sensoren GmbH, Bietigheim-Bissingen (DE)

(72) Inventors: Jean-Francois Bariant, Bietigheim-Bissingen (DE); Tino Milschewski, Bietigheim-Bissingen (DE); Ahmed Kotb, Cairo (EG); Anto Michael, Bietigheim-Bissingen (DE); Markus Heimberger, Bietigheim-Bissingen (DE)

(73) Assignee: Valeo Schalter und Sensoren GmbH, Bietigheim-Bissingen (DE)

(21) Appl. No.: 16/475,547

(22) PCT Filed: Nov. 27, 2017
(86) PCT No.: PCT/EP2017/080450

§ 371 Date: Jul. 2, 2019

(30) Foreign Application Priority Data
Jan. 3, 2017 (DE) 10 2017 100 060.7

(51) Int. Cl. G08G 1/01

(52) U.S. Cl. CPC G08G 1/01; G01S 13/931

(57) ABSTRACT

The invention relates to a method for determining movement information, in particular for a vehicle assistance system (20), with a first and a second surroundings sensor (22, 24), comprising the steps of determining a first key pose (16) of a first surroundings sensor (22) at a first reference time, wherein the first key pose (16) supplies a feature set of the surroundings of a position, determining a first feature set (18) with the first surroundings sensor (22) at a first reference time plus a first time difference relative to the first key pose (16), determining a second key pose (16) of a second surroundings sensor (24) at a second reference time, wherein the second key pose (16) supplies a feature set of the surroundings of a position, determining a second feature set (18) with the second surroundings sensor (24) at a second reference time plus a second time difference relative to the second key pose (16), determining a first relative change in position from the features of the first feature set (18) with respect to the first key pose (16) and a second relative change in position from the features of the second feature set (18) with respect to the second key pose (16), and estimating the movement information on the basis of the first and second changes in position of the first and second surroundings sensors (22, 24) together with the first and second reference times and the first and second time differences.

The present invention relates to a method for determining movement information, in particular for a vehicle assistance system, with a first and a second surroundings sensor.

The present invention also relates to an interface device for a vehicle assistance system with a first and a second surroundings sensor.

Furthermore, the present invention relates to a computer program product for carrying out the above method.

The present invention further relates to a vehicle assistance system with a first and a second surroundings sensor and a control device which is connected to the first and second surroundings sensors via an interface device.

The present invention also relates to a vehicle with a vehicle assistance system as above.

In the prior art, a variety of approaches are known for acquiring movement information. Therefore, for example approaches for fusing sensor data in conjunction with simultaneous localization and mapping (SLAM) methods are known in the prior art. These methods are based on extracting features and carrying out feature-based fusion and localization.

These methods are suitable only to a limited degree or are too costly for determining movement information in a real environment, i.e. for example a movement by a distance at an angle. The extraction of features is in complex method.

U.S. Pat. No. 7,426,449 B2 discloses a measurement data processing system which fuses measurement data from a set of independent, self-validating (SEVA) process sensors which monitor the same real time measurement variable, in order to generate a combined, best estimation for the value, the uncertainty and the measurement status of the measurement variable. The system also offers consistency checking between the measurements. The measurement data processing system comprises a first process sensor and a second process sensor. Each of the first and second process sensors receives a measurement signal from a transducer and generates an independent process metric. A measurement fusion block is connected to the first and second process sensors, wherein the measurement fusion block can be operated to receive the independent process metrics and to carry out a measurement analysis process for analysing the independent process metrics and to generate the combined, best estimates of the independent process metrics.

Furthermore, U.S. Pat. No. 8,417,490 B1 discloses a system and a method for providing integrated methods for an integrated software development environment for the design, the checking and the validation of advanced automobile safety systems. The system permits automotive software, which is developed on a host computer, to use a collection of computer programs simultaneously as processes and to be synchronized by a central process. The software uses separate, synchronized processes which permit signals from various sources to be generated in the host computer on a real time basis by means of a simulation running on the host computer or by means of actual sensors and data bus signals which by actual vehicle hardware which is connected to their bus counterparts.

Taking the abovementioned prior art as a starting point, the invention is therefore based on the object of specifying a method for determining movement information, in particular for a vehicle assistance system, with a multiplicity of surroundings sensors, an interface device for a vehicle assistance system with a first and a second surroundings sensor, a computer program product for carrying out the above method, a vehicle assistance system with a first and a second surroundings sensor and a control device which is connected to the first and second surroundings sensors via the above interface device, as well as a vehicle with a vehicle assistance system as above, which permit simple and robust determination of movement information.

The object is achieved according to the invention by means of the features of the independent claims. Advantageous refinements of the invention are specified in the dependent claims.

According to the invention, a method for determining movement information is therefore specified, in particular for a vehicle assistance system, with a first and a second surroundings sensor, comprising the steps of determining a first key pose of a first surroundings sensor at a first reference time, wherein the first key pose supplies a feature set of the surroundings of a position, determining a first feature set with the first surroundings sensor at a first reference time plus a first time difference relative to the first key pose, determining a second key pose of a second surroundings sensor at a second reference time, wherein the second key pose supplies a feature set of the surroundings of a position, determining a second feature set with the second surroundings sensor at a second reference time plus a second time difference relative to the second key pose, determining a first relative change in position from the features of the first feature set with respect to the first key pose and a second relative change in position from the features of the second feature set with respect to the second key pose, and estimating the movement information on the basis of the first and second changes in position of the first and second surroundings sensors together with the first and second reference times and the first and second time differences.

According to the invention, an interface device for a vehicle assistance system with a first and a second surroundings sensor is also specified, the interface device having an interface for receiving a first or second key pose from the first or second surroundings sensor, and an interface for receiving a first or second feature set relative to the first or second key pose from the first or second surroundings sensor.

Furthermore, according to the invention, a computer program product for carrying out the above method is specified.

According to the invention, a vehicle assistance system with a first and a second surroundings sensor and a control device which is connected to the first and second surroundings sensors via an interface device is further specified, wherein the vehicle assistance system is designed to carry out the method specified above.

According to the invention, a vehicle with a vehicle assistance system as above is also specified.

The basic concept of the present invention is therefore to provide, by means of the definition of the key poses, reference variables which can be used to compare feature sets generated during subsequent sensor measurements with the features of the key poses. In this context, the features of the respective key pose and of the corresponding feature set can be mapped one on top of the other in order to determine the change in position of the surroundings sensor. Two movement information items are therefore obtained from the change in position together with the associated time difference for the two surroundings sensors. In this context, the method is simpler than a general feature extraction as in the prior art.

A feature has characteristic properties which can be detected by the respective surroundings sensor. A feature therefore constitutes a simple geometric primitive which is determined directly by the sensor or the ad hoc algorithm thereof. The features can be based on real objects, for example a vehicle, a road sign, a mast, a kerbstone or other objects.

A feature set correspondingly comprises a totality of features which can be respectively sensed by an surroundings sensor. The feature set is therefore a result of a sensor measurement with a surroundings sensor, wherein the individual features are extracted from the sensor information. In this context it is desirable that the sensor measurements are carried out as far as possible in an unfiltered fashion, i.e. without preceding image processing, for example on the basis of a history.

Correspondingly, a key pose and the corresponding feature set do not differ in principle but only in their function, wherein a key pose is used respectively as a reference for further feature sets which have been determined with the corresponding surroundings sensor.

In principle, the method can also be extended to a multiplicity of surroundings sensors, wherein the processing takes place in a manner corresponding to that described for the two surroundings sensors. In this context, in principle, any desired types of surroundings sensors can be used and combined.

In the method it is irrelevant how the first and second reference times and the first and second time differences are selected. The reference times and time differences can have different values for different surroundings sensors. The determination of the respective key poses and feature sets can in principle take place completely asynchronously.

The sequence in which individual steps are carried out is also in principle irrelevant for the method. Therefore, changes in position can be determined for each surroundings sensor independently of one another. The estimation of the movement information can in principle be carried out here randomly on the basis of respectively currently available changes in position.

When the movement information is estimated on the basis of the first and second changes in position of the first and second surroundings sensors it is necessary for the respective reference times to be able to be assigned to a common timescale. In this context, preferably continuous updating of the vehicle movement can take place. The movement information can therefore be estimated even if, for example, the first or second surroundings sensor has not provided a current feature set.

Further first or second feature sets are determined as described above, wherein only the value for the corresponding time difference changes. An estimation of the movement information can be readily carried out.

In addition, key poses can be transmitted onto a map. This can be carried out, for example, in order to define a trajectory by means of key poses. Correspondingly, the key poses can be used starting from their position on the map as references for the trajectory. In this context it is common that the vehicle position is defined by means of the rear axle, for example the centre point of the rear axle.

In one advantageous refinement of the invention, the method comprises the step of receiving external movement information, and the step of estimating movement information on the basis of the first and second changes in position of the first and second surroundings sensors together with the first and second reference times and the first and second time differences comprises estimating movement information on the basis of the external movement information and the first and second changes in the position of the first and second surroundings sensors together with the first and second reference times and the first and second time differences. By taking into account further information with respect to the movement, the estimation of the movement information can be improved further. Moreover, initialization of individival method steps can take place by means of the external movement information, as a result of which the execution of the method can be speeded up and/or improved. In particular, when the movement information is estimated, the external movement information can be adopted as an initial value, which external movement information is corrected by the first and second changes in position of the first and second surroundings sensors on the basis of the first and second reference times together with the first and second time differences.

In one advantageous refinement of the invention, the step of estimating the movement information on the basis of the external movement information and the first and second changes in position of the first and second surroundings sensors together with the first and second reference times and the first and second time differences comprises weighting the external movement information and the first and second changes in position of the first and second surroundings sensors together with the first and second reference times and the first and second time differences. As a result, a first estimation of the movement information can be corrected, for example as a function of available movement information on the basis of first and second changes in position of the first and second surroundings sensors, of the first and second reference times and of the first and second time differences. The weighting is preferably dynamically adapted during the operation. In particular, the weighting can take place as a function of an evaluation of the reliability of the external movement information and/or of the first and second changes in position of the first and second surroundings sensors together with the first and second reference times and the first and second time differences. It is therefore possible, for example, for the weighting of the first and second changes in position of the first and second surroundings sensors together with the first and second reference times and the first and second time differences to be increased as a function of a number of features detected with respect to the respective key pose.

In one advantageous refinement of the invention, the method comprises the step of checking a detection of a minimum number of features of the first or second feature set with respect to the first or second key pose, respectively, and in the event of fewer than the minimum number of features of the first or second feature set being detected with respect to the first or second key pose the method comprises the additional step of determining a further first or second key pose of the first or second surroundings sensor, respectively. Correspondingly, it is checked whether the first or second key pose is still suitable for estimating the movement information. This is the case as long as there is a sufficient number of features of the respective key pose contained in the corresponding first or second feature set to be able to determine a change in position of these features. As soon as a surroundings sensor senses a previously unknown part, a new key pose is therefore generated and, if appropriate, added to the map. As soon as a key pose is no longer suitable for estimating the movement information, a new key pose is generated for the corresponding sensor. In this context, in principle a decision is made about the generation of key poses independently for each sensor. Since the various sensors can sometimes be arranged with different viewing angles and viewing ranges, the detection of features of the individual surroundings sensors is in principle independent. A surroundings sensor can also supply, for example, no changes in position for a certain time. In this case, movement information can continue to be estimated on the basis of the other surroundings sensor. The further feature sets of the corresponding surroundings sensor are subsequently processed with respect to the further key pose.

In one advantageous refinement of the invention, the method comprises the step of transmitting the first key pose, the second key pose, the first feature set and the second feature set from the first or second surroundings sensor to a control device. Correspondingly, the method can be carried out in a decentralized fashion by part of the data processing being carried out by the surroundings sensors and part of the data processing being carried out in the control device. An interface device between the surroundings sensors and the control device ensures that all the features can be transmitted correctly. Furthermore, key poses can be stored in the control device and updated on the basis of the current feature sets of the corresponding surroundings sensor. Here, fusion of the key poses with the current feature sets can take place.

In one advantageous refinement of the invention, the transmission of the first feature set and of the second feature set from the first or second surroundings sensor to a control device comprises the transmission of a first or second change in position sensed with the first or second surroundings sensor and a description of uncertainty of the first or second change in position of the first or second feature set based on the first or second surroundings sensor. The uncertainty can in principle depend on the surroundings sensor itself, i.e. one surroundings sensor can have a higher level of accuracy than another. The uncertainty can have here, on the one hand, an accuracy level and, on the other hand, a specific type of uncertainty, for example possible direction information relating to uncertainty.

In one advantageous refinement of the invention, the transmission of a description of uncertainty of the first or second change in position of the first or second feature set on the basis of the first or second surroundings sensor comprises the transmission of a covariance matrix. The movement information can therefore be estimated on the basis of the covariance matrix and the relative changes in position. The covariance matrix makes it possible to sense uncertainties during the determination of the respective change in position. For this purpose, the uncertainty of a change in position can be represented, for example, in the form of a three-dimensional ellipsoid.

In one advantageous refinement of the invention, the steps of determining a first or second feature set relative to the first or second key pose comprise processing raw data with an ad hoc algorithm, in order to carry out the determination of positions of features with respect to the first or second key pose.

In one advantageous refinement of the invention, the step of determining a first relative change in position from the features of the first feature set with respect to the first key pose and a second relative change in position from the features of the second feature set with respect to the second key pose comprises carrying out Kalman filtering, particle filtering, an information filter or graph optimization. Such filters are known as such in principle in the prior art and can be used to subsequently be able to process the information of the various surroundings sensors to form the estimated movement information.

In one advantageous refinement of the invention, the first and second surroundings sensors are embodied independently of one another as a laser scanner, radar, ultrasonic sensor or camera. Sensor information of the different sensors can be processed in a combined fashion without fundamental limitations, since each surroundings sensor determines its key pose and carries out a sensor measurement in its own way. The detection of features in the sensor measurements can also in principle occur in different ways. When the movement information is estimated, in this context in principle any desired types of sensors can be combined in any desired positions. In this context, the features are also respectively individual for each surroundings sensor.

In one advantageous refinement of the invention, the vehicle assistance system has an interface device as specified above, which interface device is embodied between the control unit and the first and second surroundings sensors.

In the drawing:

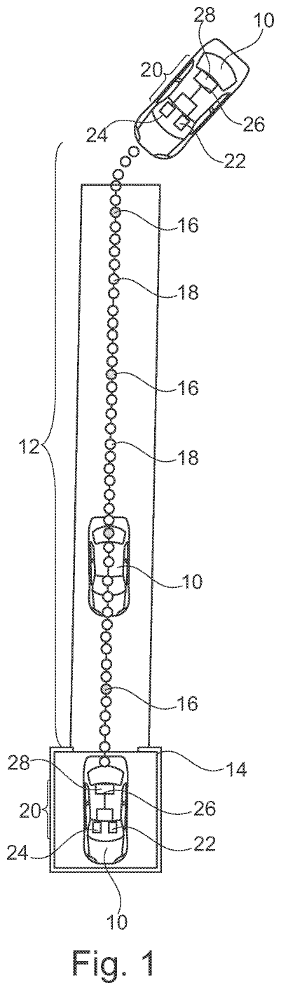

FIG. 1 shows a schematic view of a vehicle with a vehicle assistance system according to a first, preferred embodiment on a trajectory which is travelled along, and

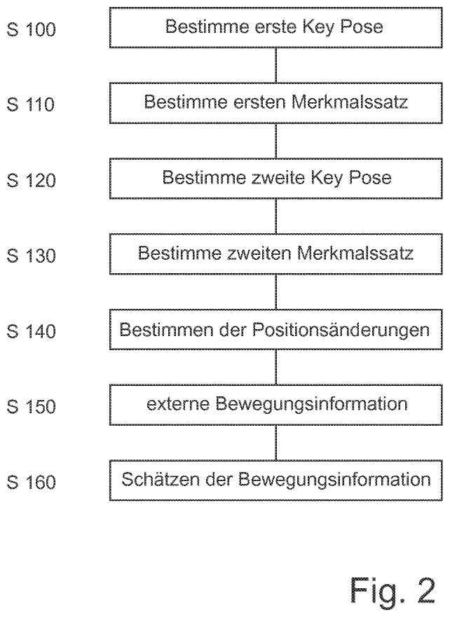

FIG. 2 shows a flowchart of a method for determining movement information for the vehicle assistance system in accordance with the first embodiment.

FIG. 1 shows a schematic view of a vehicle 10, which is moving along a trajectory 12 in this exemplary embodiment to a destination represented here by a garage 14.

According to the first, preferred embodiment, the vehicle 10 is embodied with a vehicle assistance system 20. The vehicle assistance system 20 comprises a first and a second surroundings sensor 22, 24, which sensors are connected to a control device 28 via an interface device 26. The first and second surroundings sensors 22, 24 are embodied independently of one another as a laser scanner, radar, ultrasonic sensor or camera.

A flowchart of a method according to the invention for determining movement information for the vehicle assistance system 20 in the vehicle 10 according to the first embodiment is illustrated in FIG. 2. The following general definitions apply to the method.

A feature has characteristic properties which can be detected by the respective surroundings sensor. A feature therefore constitutes a simple geometric primitive which is determined directly by the sensor or the ad hoc algorithm thereof. The features can be based on real objects, for example a vehicle, a road sign, a mast, a kerbstone, or other objects.

During the movement along the trajectory 12, each surroundings sensor 22, 24 independently forms key poses 16 as a reference for the determination of movement information. In addition, each surroundings sensor 22, 24 independently forms feature sets 18, for which a change in position with respect to the respective key pose 16 is determined. Correspondingly, in FIG. 1 the trajectory 12 is illustrated by way of example with key poses 16 and feature sets 18 which can, for example, be first key poses 16 and first feature sets 18 or second key poses 16 and second feature sets 18. The key poses 16 and feature sets 18 are illustrated here, by way of example, as dots along the trajectory 12, wherein the dots each indicate a position which corresponds to the corresponding key pose 16 or the feature set 18.

A feature set 18 is a result of a sensor measurement with a surroundings sensor 22, 24 and comprises a totality of features which are respectively sensed by a surroundings sensor 22, 24, wherein the individual features are extracted from the sensor information. The sensor measurements are carried out in an unfiltered fashion.

In principle, the method can also be extended to a multiplicity of surroundings sensors 22, 24, wherein the processing takes place in a manner corresponding to that described for the two surroundings sensors 22, 24.

The method starts with step S100, which relates to the determination of a first key pose 16 of a first surroundings sensor 22 at a first reference time. The first key pose 16 supplies a feature set of the surroundings of a position.

In step S110 a first feature set 18 is subsequently determined with the first surroundings sensor 22 at a first reference time plus a first time difference relative to the first key pose 16.

In accordance with steps S100 and S110, in step S120 a second key pose 16 of a second surroundings sensor 24 is determined at a second reference time, wherein the second key pose 16 supplies a feature set of the surroundings of a position, and in step S130 a second feature set 18 is determined with the second surroundings sensor 24 at a second reference time plus a second time difference relative to the second key pose 16.

In this context, in steps S100 and S120 the two determined key poses 16 are additionally transmitted onto a map, as illustrated by way of example in FIG. 1. In this context, a vehicle position is defined by way of a centre point of the rear axle of the vehicle 10.

The determination of the first and second feature sets 18 relative to the first and second key poses 16 in the steps S110 and S130 respectively comprises the processing of raw data with an ad hoc algorithm, in order to carry out the determination of positions of features with respect to the first and second key poses 16.

In this context, in steps S110 and S130, checking of a detection of a minimum number of features of the first and second feature sets 18 with respect to the first and second key poses 16 is respectively carried out. In the event of fewer than the minimum number of features of the first or second feature set 18 being detected with respect to the first or second key pose 16, a further first or second key pose 16 of the first or second surroundings sensor 22, 24 is determined in the steps S100 and S120, respectively. This takes place independently for each surroundings sensor 22, 24.

In step S140, a first relative change in position is determined from the features of the first feature set 18 with respect to the first key pose 16 and a second relative change in position is determined from the features of the second feature set 18 with respect to the second key pose 16. The concluding fusion comprises carrying out Kalman filtering, particle filtering, an information filter or graphic optimization, in order to process the information of the various surroundings sensors 22, 24 to form the estimated movement information.

In addition, the first key pose 16, the second key pose 16 and a first or second change in position which has been sensed with the first or second surroundings sensor 22, 24, and a description of uncertainty of the first or second change in position are transmitted. The transmission of a description of uncertainty of the first or second change in position of the first or second feature set 18 on the basis of the first or second surroundings sensor 22, 24 comprises the transmission of a covariance matrix. The interface device 26 has in each case a corresponding interface for the transmission.

In step S150, external movement information of the vehicle 10 based on odometry information of the vehicle 10 is transmitted to the control device 28.

In step S160, the movement information is estimated on the basis of the external movement information and the estimated movement information according to step S140 in which the first and second changes in position of the first and second surroundings sensors 22, 24 were processed to form the estimated movement information. If appropriate, updating of the vehicle movement takes place when the movement information is estimated.

In addition, the external movement information and the first and second changes in position of the first and second surroundings sensors 22, 24 are weighted. The weighting is dynamically adapted during the operation, as a function of an evaluation of the reliability of the external movement information and/or of the first and second changes in position of the first and second surroundings sensors 22, 24 together with the first and second reference times and the first and second time differences. In addition, the weighting of the first and second changes in position of the first and second surroundings sensors 22, 24 together with the first and second reference times and the first and second time differences is increased with respect to the external movement information, as a function of a number of features detected with respect to the respective key pose 16.

Further first and second feature sets 18 are determined as described above in steps S110 and S130, wherein only the value for the corresponding time difference changes. The method therefore jumps in each case independently back to the specified steps again.

### LIST OF REFERENCE NUMBERS

Vehicle 10

Trajectory 12

Garage, destination 14

Key pose 16

Feature set 18

Vehicle assistance system 20

First surroundings sensor 22

Second surroundings sensor 24

Interface device 26

Control device 28

1. A method for determining movement information, in particular for a vehicle assistance system, with a first and a second surroundings sensor, comprising:
determining a first key pose of a first surroundings sensor at a first reference time, wherein the first key pose supplies a feature set of the surroundings of a position;
determining a first feature set with the first surroundings sensor at a first reference time plus a first time difference relative to the first key pose;
determining a second key pose of a second surroundings sensor at a second reference time, wherein the second key pose supplies a feature set of the surroundings of a position;
determining a second feature set with the second surroundings sensor at a second reference time plus a second time difference relative to the second key pose;
determining a first relative change in position from the features of the first feature set with respect to the first key pose and a second relative change in position from the features of the second feature set with respect to the second key pose; and
estimating the movement information on the basis of the first and second changes in position of the first and second surroundings sensors together with the first and second reference times and the first and second time differences.

2. The method according to claim 1, further comprising:
receiving external movement information, and the step of estimating movement information on the basis of the first and second changes in position of the first and second surroundings sensors together with the first and second reference times and the first and second time differences comprises estimating movement information on the basis of the external movement information and the first and second changes in the position of the first and second surroundings sensors together with the first and second reference times and the first and second time differences.

3. The method according to claim 2, further comprising: estimating the movement information on the basis of the external movement information and the first and second changes in position of the first and second surroundings sensors together with the first and second reference times and the first and second time differences comprises weighting the external movement information and the first and second changes in position of the first and second surroundings sensors together with the first and second reference times and the first and second time differences.

4. The method according to claim 1, further comprising: checking a detection of a minimum number of features of the first or second feature set with respect to the first or second key pose, respectively, and in the event of fewer than the minimum number of features of the first or second feature set being detected with respect to the first or second key pose the method comprises the additional step of determining a further first or second key pose of the first or second surroundings sensor, respectively.

5. The method according to claim 1, further comprising: transmitting the first key pose, the second key pose, the first feature set and the second feature set from the first or second surroundings sensor to a control device.

6. The method according to claim 5, wherein the transmission of the first feature set and of the second feature set from the first or second surroundings sensor to a control device comprises the transmission of a first or second change in position sensed with the first or second surroundings sensor and a description of uncertainty of the first or second change in position of the first or second feature set based on the first or second surroundings sensor.

7. The method according to claim 6, wherein the transmission of a description of uncertainty of the first or second change in position of the first or second feature set on the basis of the first or second surroundings sensor comprises the transmission of a covariance matrix.

8. The method according to claim 1, wherein determining a first or second feature set relative to the first or second key pose comprise processing raw data with an ad hoc algorithm, in order to carry out the determination of positions of features with respect to the first or second key pose.

9. The method according to claim 1, wherein determining a first relative change in position from the features of the first feature set with respect to the first key pose and a second relative change in position from the features of the second feature set with respect to the second key pose comprises carrying out one selected from the group consisting of: Kalman filtering, particle filtering, an information filter and graph optimization.

10. An interface device for a vehicle assistance system with a first and a second surroundings sensor, the interface device,. comprising:
an interface for receiving a first or second key pose from the first or second surroundings sensor; and
an interface for receiving a first or second feature set relative to the first or second key pose from the first or second surroundings sensor.

11. A non-transitory computer program product for carrying out the method according to claim 1.

12. The vehicle assistance system with a first and a second surroundings sensor and a control device which is connected to the first and second surroundings sensors via an interface device, wherein the vehicle assistance system is configured to carry out the method according to claim 1.

13. The vehicle assistance system according to claim 12, wherein the first and second surroundings sensors are embodied independently of one another as one selected from the group consisting of: a laser scanner, radar, ultrasonic sensor and camera.

14. The vehicle assistance system according to claim 12, wherein the vehicle assistance system comprises:
an interface device, comprising: an interface for receiving a first or second key pose from the first or second surroundings sensor; and an interface for receiving a first or second feature set relative to the first or second key pose from the first or second surroundings sensor,
wherein the interface device is embodied between the control unit and the first and second surroundings sensors.

15. A vehicle with a vehicle assistance system according to claim 12.
